(19) United States
(12) Patent Application Publication
(10) Pub. No.: US 2024/0344996 A1
(43) Pub. Date: Oct. 17, 2024

(54) MATERIAL CHARACTERIZATION USING COLD ATMOSPHERIC PLASMA

(71) Applicant: SirenOpt Inc., Oakland, CA (US)

(72) Inventors: Ali MESBAH, Danville, CA (US); Jared O'LEARY, Oakland, CA (US)

(21) Appl. No.: 18/743,050

(22) Filed: Jun. 13, 2024

Related U.S. Application Data
(63) Continuation of application No. PCT/US2024/024008, filed on Apr. 11, 2024.
(60) Provisional application No. 63/507,860, filed on Jun. 13, 2023.
(60) Provisional application No. 63/507,855, filed on Jun. 13, 2023.
(60) Provisional application No. 63/496,110, filed on Apr. 14, 2023.

(51) Int. Cl. G01N 21/73

(52) U.S. Cl. CPC G01N 21/73; G01N 2201/1296

(57) ABSTRACT

A system to collect sensor data from an interaction between a plasma and a material and use a machine learning system to characterize the material. A method and apparatus for characterizing and evaluating a material. The method includes in one embodiment applying a cold atmospheric plasma to an interface with the material, measuring a plurality of interactions between the plasma and the interface using a plurality of sensors to generate sensor data, and utilizing a trained machine learning model to analyze the sensor data to generate characterization of the bulk and/or surface material properties based on the interactions.

### 1. RELATED APPLICATION

The present application claims priority to U.S. Provisional Patent Applications No. 63/507,855, filed on Jun. 13, 2023, and 63/507,860, filed on Jun. 13, 2023, and PCT Application No. PCT/US24/24008, filed on Apr. 11, 2024, which claims priority to U.S. Provisional Application No. 63/496,110, filed on Apr. 14, 2023, each of which is incorporated by reference in its entirety.

### 2. TECHNICAL FIELD

The subject matter described relates generally to material analysis and, in particular, to using machine learning with data collected using a low-temperature plasma source interacting with an interface for characterizing materials.

### 2. BACKGROUND INFORMATION

Surface material characterization and evaluation is used in many modern manufacturing technologies. Measuring material properties, has applications in optics, microelectronics, mechanics, chemistry, medicine, batteries, and magnetic devices, among others.

As high-volume manufacturing industries continue to scale, real-time quality control of fabricated devices becomes disproportionately challenging since not every device can be checked for multiple critical properties without compromising throughput. A common process control practice is to measure inline process variables/attributes that can provide indirect information about critical properties of a manufactured device and then send a certain percentage of devices for offline measurement of their critical properties, which is often destructive. This approach to process monitoring and statistical process control limits the amount of actionable data collected inline and, more importantly, can delay direct access to actionable data about critical device properties for real-time decision-making and process optimization.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an overview illustration of one embodiment of a cold atmospheric plasma system.

FIG. 2 is an overview block diagram of one embodiment of a material characterization system using plasma.

FIG. 3 is a block diagram of one embodiment of the training system.

FIG. 4 is a block diagram of the material characterization system.

FIG. 5 is an overview flowchart of a method for characterizing one or more surface properties, according to one embodiment.

FIGS. 6A-B illustrate optical emissions spectra from copper, aluminum, silicon, Kapton polyimide film, and glass samples.

FIG. 7 illustrates the correlation between the distribution of surface temperature in response to the cold atmospheric plasma versus the known thermal diffusivity of each material, as reported in literature.

FIG. 8 illustrates the correlation of the measured resistivity of various materials versus the known resistivity of each material, as reported in literature.

FIG. 9 illustrates a measurement of a battery anode chemical composition, thickness, and resistivity, according to one embodiment.

FIG. 10 illustrates measurements of the battery anode mass loading.

FIG. 11 illustrates detection of battery cathode performance grade, according to one embodiment.

FIG. 12 illustrates a detection of contaminants, wrinkles, and classification of strain response in polymer films, according to one embodiment.

FIG. 13 illustrates a detection of membrane performance grade, according to one embodiment.

FIG. 14 is a Sankey Chart of one embodiment of exemplary types of materials analyzed and characteristics identified.

FIG. 15 is a block diagram of an exemplary processing system, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Overview

A cold atmospheric plasma is a weakly ionized gas comprising of a blend of electrons, ions, neutrals, and reactive species at non-thermal equilibrium. Cold atmospheric plasmas may be used for surface metrology and material evaluation, measuring material characteristics at an interface. In various embodiments, a surface metrology system and method use the thermal, electrical and chemical interactions of cold atmospheric plasmas with an interface of a material to characterize one or more properties of the material. In one embodiment, the system uses an atmospheric pressure plasma jet (APPJ). The APPJ discharges a cold atmospheric plasma, the plasma power and plasma/material interface interactions are controlled by a set of jet parameters, such as the rate of flow of gas (e.g., helium) and the voltage applied. In other embodiments, other types and configurations of cold atmospheric plasma sources may be used.

A real-time, non-destructive and multi-modal metrology technology for micro-and nano-scale materials can create unprecedented opportunities for implementation of smart manufacturing practices and advanced process control solutions. Such decision-making capabilities can significantly reduce variability in product quality and production of off-spec devices, as well as drastically accelerate process optimization and yield ramp, reduce material waste, and realize higher precision and production throughput.

One or more sensors are used to take readings that provide information about the interaction between the cold atmospheric plasma and the material. These sensor readings include information about the electrical, thermal, and/or chemical interactions between the plasma and the interface. For example, a thermal camera can be used to obtain a temperature distribution on the surface and an optical emissions spectrometer (OES) may be used to record plasma intensity from optical emissions at different wavelengths, and a voltage and/or current meter can be used to record the electrical characteristics. The obtained sensor readings may be processed to obtain characterizations of one or more properties of the material.

In one embodiment, the sensor readings are provided to a processor system. The processor system may extract features from the sensor readings to provide to a trained machine learning (ML) model and/or provide the sensor readings to the ML model. In one embodiment, the processor system uses a mix of approaches, for example providing peaks identified in spectroscopy data/optical emission data and raw temperature readings to the model. The trained ML model generates characterizations and/or performance evaluation for one or more properties of the material, such as material type, material composition, thickness, uniformity, or presence of contaminants, etc. In one embodiment, the system can provide one or more of direct property measurements, application specific classification, and predictions of functional properties.

The described system has the capability of translating the chemical, thermal and electrical signatures of a material's response to cold plasma into multiple physical and chemical properties of micro-and nano-scale materials in parallel and in real time. This is enabled by a physics-informed machine learning model that takes as input the sensor data-which may include optical emission spectra, thermal images and electrical characteristic data-and produces the material characteristics. The present system can determine, in some embodiments, one or more of: surface type, thickness and uniformity, density, resistivity, chemical composition, contaminate, mass loading, and defect identification for thin-films and other coatings, as well as broader classifications related to material performance.

### Example Systems

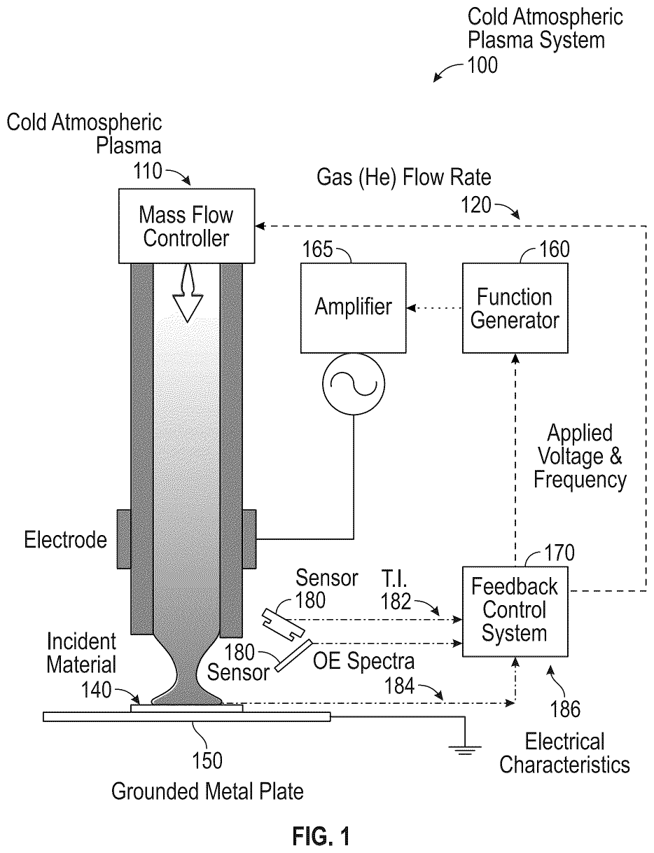

FIG. 1 is an overview illustration of one embodiment of a cold atmospheric plasma system. The plasma system includes a plasma source 110, which is controlled by a combination of gas flow rate 120 and applied voltage and frequency. The plasma is incident on a material 140, which rests on a grounded metal plate 150, in one embodiment. The plasma may be used for characterizing the incident material 140.

The cold atmospheric plasma source 110 receives control signals from a function generator 160, which may be amplified by amplifier 165.

The function generator 160 in one embodiment generates a signal used to drive the amplifier. The function generator 160 receives control signals from the feedback control system 170, which calculates the voltage and frequency to be applied to the cold atmospheric plasma source 110. The feedback & control system 170 receives sensor data from sensors 180. In one embodiment the sensor data includes a thermal image (T.I) 182, optical emission (O.E.) spectra 184, and electrical characteristics 186. Based on this sensor data, feedback control system 170 controls function generator 160 and gas flow rate 120, and other gas admixture flow. In this way, the cold atmospheric plasma system 100 is used to interact with the incident material 140.

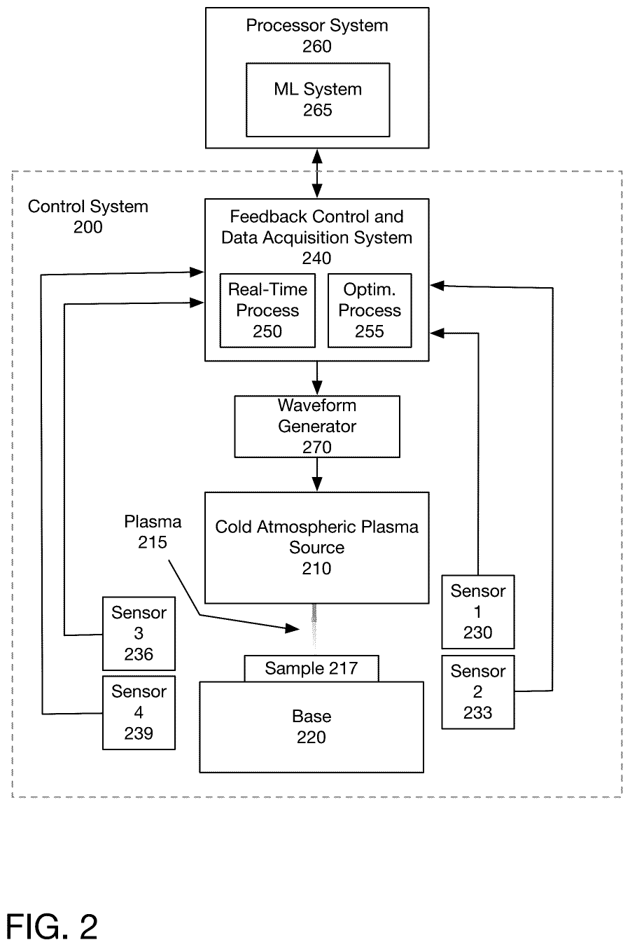

FIG. 2 is an overview block diagram of one embodiment of a material characterization and evaluation system using plasma. The system includes a control system 200 and processor system 260. In one embodiment, the processor system 260 is a distributed system remote from control system 200.

The cold atmospheric plasma source 210 receives applied voltage and frequency via waveform generator 270, which is controlled by feedback control and data acquisition system 240. The cold atmospheric plasma source 210 produces plasma 215 which is incident on a sample 217. In one embodiment, the sample rests on a base 220. Sensors (here shown as sensors 1-4 230, 233, 236, 239) monitor the plasma 215 and sample 217. In one embodiment, one or more of the sensors may be sensing characteristics of the plasma 215. In one embodiment, one or more of the sensors may be sensing characteristics of the sample 217. Although four sensors are shown here, a real implementation may include one or more sensors.

The various sensors 230, 233, 236, 239 may include an optical emissions spectrometer, an image sensor, an infrared camera, voltage and/or current detector, etc. The optical emission spectrometer can (indirectly) provide information about the chemical characteristics of the material. In one embodiment, the optical emissions spectrometer may measure the optical intensity of the plasma plume at the point where the plasma plume is incident on the material, and/or may include multiple sensors to take multiple measurements at various positions with respect to the plasma plume and the material. The image sensor may take an image of the plasma plume at the point it is incident on the material. The infrared camera may be used to determine the thermal response can be indicative of the bulk properties of the material sample. The electrical characteristic measurement may be made by a Root Mean Square (RMS) voltage sensor, a waveform voltage sensor, an RMS current sensor, and/or a waveform current sensor. In one embodiment, a bias may be applied to the material, base, or plasma plume to direct the electrical effects of plasma via a bias system. If such a bias system is used, the applied bias may be read by another sensor. Biasing may also be used to direct the plasma plume. Biasing in one embodiment can improve the collection of electrical data.

Other types of sensors may include sensors to measure electromagnetic intensity of the plasma or the material, photonic intensity of the plasma or the material.

In one embodiment, sensors may include: Atomic force microscope (AFM), Atomic force microscope (AFM) nanoindentation, BET analyzer, Brinell hardness tester, Capacitance meter, Capacitance-based sensor, Charged-coupled device (CCD) camera, Complementary metal-oxide-semiconductor (CMOS) (and Scientific CMOS) Detector, Complementary metal-oxide-semiconductor camera (CMOS), Compression tester, Conductive atomic force microscope (AFM), Conductivity meter, Contact angle goniometer, Dielectric spectrometer, Differential scanning calorimeter (DSC), Dilatometer, Dynamic mechanical analyzer (DMA), Electrometer, Electron backscatter diffraction (EBSD), Electron Energy Analyzer, Electron multiplied charged-coupled device (EMCCD), Electrostatic voltmeter, Ellipsometer, Energy-dispersive X-ray spectroscopy (EDS), Falling ball viscometer, Fluorometer, Four-point probe, Gas adsorption analyzer (e.g., Hall effect sensor, Hyperspectral camera, Impedance analyzer, Infrared camera, Infrared spectroscope, Interferometric dilatometer, Inverse gas chromatography (IGC), Isothermal calorimeter, Kelvin probe, Kelvin Probe Force Microscopy (KPFM), Langmuir Probe, Laser displacement sensor, Laser flash analysis, Laser scattering probe (e.g., Thompson scatter probe), Long-wave infrared (LWIR) sensor, Luminescence microscope, Luminescence spectroscope, Magnetic force microscope (MFM), Magnetic susceptibility balance, Mass spectrometer, Melting point apparatus, Mercury porosimeter, Mid-wave infrared (MWIR) sensor, Multichannel spectroscopy, Nano-mechanical tester, Neutron diffraction, NMOS Detector, Nonlinear optical microscope, Nonlinear optical spectroscope, Nuclear magnetic resonance (NMR) spectrometer, Optical fiber spectrometer, Optical interferometer, Optical microscope with high magnification, Optical spectrum analyzer, Peel tester, Pendant drop method, Phosphor screen, Photomultiplier tube, Profilometer, Pull-off adhesion tester (e.g., Raman Microscope, Raman Spectroscope, Reaction calorimeter, Reflectometer, Rockwell hardness tester, rotational or capillary), Scanning electron microscope (SEM), Scratch tester, Secondary ion mass spectrometry (SIMS), Short-wave infrared (SWIR) sensor, Spectrofluorometer, Spectrophotometer, SPR biosensor, SPR imaging, SQUID magnetometer, Streak camera, Surface energy analyzer, Surface plasmon resonance (SPR) spectroscopy, tensile or shear), Tensile tester, Tensiometer, Thermal conductivity meter, Thermal desorption spectroscopy (TDS), Thermal mechanical analyzer (TMA), Thermogravimetric analyzer (TGA), Thermomechanical analyzer (TMA), Time-resolved microscope, Time-resolved spectroscope, Transient plane source (TPS) method, Transmission electron microscope (TEM), Two-dimension optical spectroscope, Two-dimensional optical microscope, Universal testing machine (UTM), UV-Vis-NIR spectrometer, Van der Pauw method, Vibrating sample magnetometer (VSM), Vibrational viscometer, Vickers hardness tester, Viscometer (e.g., White light interferometer, Wilhelmy plate method, X-ray diffraction (XRD), X-ray photoelectron spectroscopy (XPS), etc.

The feedback control and data acquisition system 240 receives the sensor data from sensors 230, 233, 236, 239. The feedback control and data acquisition system 240 performs calculations based on the sensor data, and outputs control signals to waveform generator 270 and flow control to adjust the cold atmospheric plasma source 210. The feedback control and data acquisition system 240 infers the power level of the plasma 215, compares this “measured” power with a power setpoint, and outputs applied voltage and frequency to the waveform generator 270 to regulate the plasma power. The feedback control and data acquisition system 240 controls the plasma-interface interactions to ensure minimally destructive material characterization.

The feedback control and data acquisition system 240 in one embodiment includes a real-time process 250 which utilizes a deep neural network based model predictive control (MPC) system, or a robust or stochastic variant of MPC. In another embodiment, the real-time process may use an MPC system that is not based on a deep neural network. The inputs to the real time process 250 are the goals (e.g., desired plasma settings) and the sensor data from the various sensors. The output of the real time process 250 are control signals for the low temperature plasma source, including controls for the waveform generator 270 and flow control. By using the deep neural network based MPC system, the real-time process 250 can provide rapid adjustments to the plasma source 210. In one embodiment, the adjustment is sub-milli-second, also referred to as real-time. Furthermore, the real-time process 250 has a small memory footprint, is cheap to evaluate, and can be run on an embedded system. The deep neural network approximation of the MPC replaces the online optimization problem with an explicit constrained multivariable control law, which can be rapidly and cheaply evaluated, to provide real-time control. The real-time process 250 is trained and optimized specifically for the control objective, e.g., controlling the nonlinear effects of plasma on the sample 217, to ensure minimally destructive characterization and evaluation of material.

The feedback control and data acquisition system 240 also includes an optimization process 255 in one embodiment. The optimization process 255 also receives sensor data and uses the sensor data to evaluate the plasma effects on the sample 217 to adapt the parameters of the real-time process 250. The optimization process 255 in one embodiment utilizes a Bayesian optimization to evaluate the functioning of the real-time process and adjust the real-time process. In one embodiment, when no deep neural network is used, the optimization process 255 can directly adjust the parameters and cost function of the MPC used by the real-time process 250 to address drifting or other issues. When the real-time process 250 is based on a deep neural network approximation of the MPC, the parameters of the deep neural network are adapted based on the input from the optimization process 255. The optimization process 255 may be slower than the real-time process 250. The optimization process 255 in one embodiment is on a run-to-run basis, evaluating the performance of the plasma source 210 and the real-time process 250 after the completion of the plasma process run. In another embodiment, the optimization process 255 may be active during the plasma process, but on a slower basis. The optimization process 255 in one embodiment receives sensor data from sensors that quantify the plasma effects on the surface, which are not measured in real-time.

The processor system 260 may be a computing system including computer, a server, one or more computers, a cloud computing system, a distributed computing system, etc. The processor system 260 is used to train the machine learning system 265, in one embodiment. In one embodiment, the machine learning system 265 is used for material property prediction, as will be described below.

In one embodiment, the processor system 260 may also be used to evaluate the sensor data directly to identify material features or classifications based on the data from the system 200, without the use of a machine learning system 265. Direct evaluation of sensor data may be used to identify material features, for example, non-homogeneities, non-uniformities, variations and similar regions of interest in a material sample.

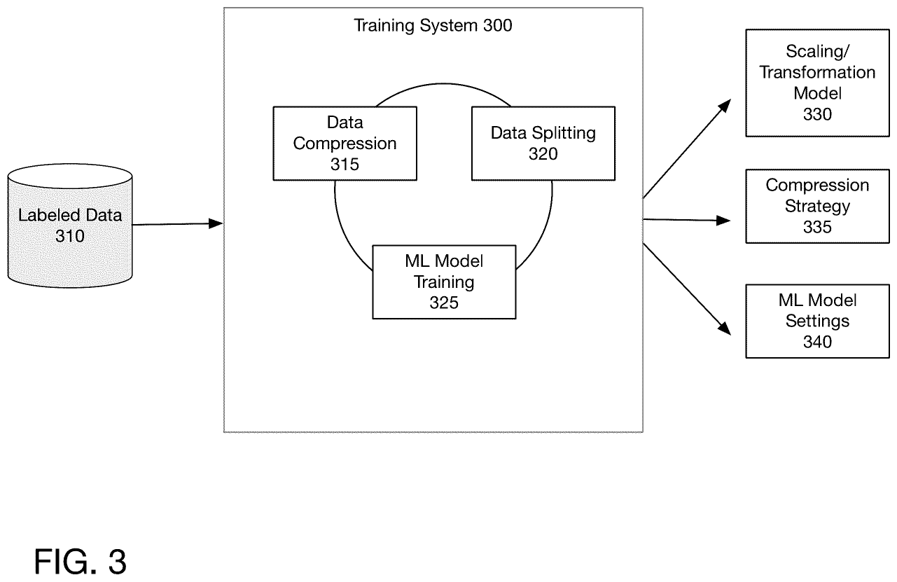

FIG. 3 is a block diagram of one embodiment of the training system. The training system 300 receives labeled data 310 of reference measurements. These reference measurements are generally determined by destructive or laborious metrology techniques that are not suitable for workflows that would require rapid, non-destructive measurements of multiple material properties in parallel. In one embodiment, the reference measurements can also take the form of or include broader quality control (QC)-relevant classifications, such as “well-performing” versus “poorly performing” materials. Note that the physical, optical, chemical, thermal, electrical, and/or electro-magnetic measurements collected by the sensors are sensitive to variabilities in the plasma-material interactions, as well as the inherent spatial variability in a sample. Accounting for such variabilities in the reference samples further boosts the accuracy of the internal model in property predictions.

In one embodiment, the physics-informed machine learning model is calibrated for each new material property with reference measurements from labeled samples 310. In one embodiment, less than 30 unique samples are used for the material properties.

The training system 300 in one embodiment provides data compression 315, data splitting 320, and ML model training 325, and each of these features are determined jointly based on the training data.

In one embodiment, the training system 300 calibration procedure outputs: (i) strategies for optimal data compression 335, (ii) strategies for a scaling and transformation model 330 of the physical, optical, chemical, thermal, electrical, and/or electro-magnetic measurements, and (iii) a supervised learning model 340 that takes in the compressed, scaled, and transformed data to predict multiple material properties in parallel and in a real time. In one embodiment, the supervised learning model 340 uses nonlinear regression and classification techniques to relate raw data to labels. In one embodiment, the system uses data compression and scaling strategies to enhance model performance, generalizability, and compute speed.

In one embodiment, the training system model 300 relies on a computationally efficient, probabilistic machine learning paradigm, such as Gaussian Process regression models (GPs). GPs are suited to train the internal model using a limited number of reference samples. As a probabilistic model, GPs hinge on the concept that data points in close proximity in the input space are likely to be similar in the output space. This is achieved through an autocorrelation function that quantifies pairwise distances among training and test data points. Given a new data point, a GP model can predict unseen data as a Gaussian distribution, meaning each prediction includes a mean and a variance (i.e., a prediction of a property value and an estimate of uncertainty of the prediction). This feature is particularly useful since GPs automatically provide predictive confidence bounds and, thus, facilitate a range of unique applications in quality control and real-time process control. The uncertainty quantification represents how “confident” the internal model is in its predictions based on the distribution of the calibration data. In this way, the model can directly inform the user about: (i) which reference samples can be further added to the model training data to improve the prediction quality of the internal model; and (ii) how “well-calibrated” the internal model is. In another embodiment, the training system model 300 may be a Bayesian neural network.

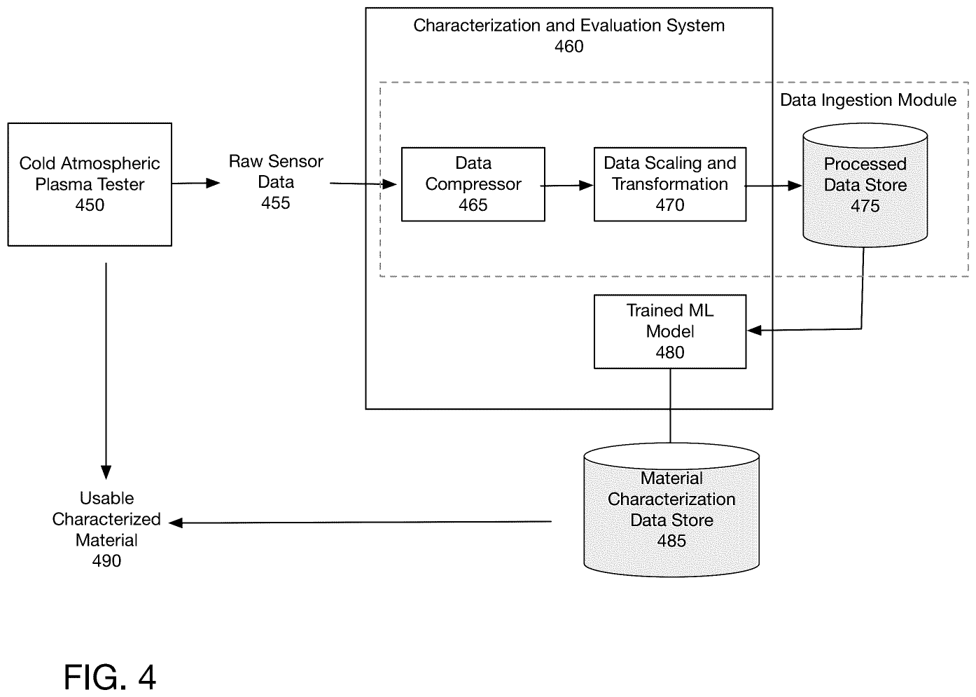

FIG. 4 is a block diagram of the material characterization and evaluation system. The cold atmospheric plasma tester 450 includes a plurality of sensors, as discussed above. The sensor data 455 is input to characterization and evaluation system 460. In one embodiment, the sensor data includes optical emissions spectra from the plasma (e.g., as obtained by the OES), surface temperature distributions (e.g., as obtained by the thermal camera), electrical measurements (e.g., as obtained by a voltage and/or current sensor), and electro-magnetic measurements (e.g., as obtained by an UV-Vis spectrometer). The data may include an optical emissions spectrum, spatio-temporal distribution of surface temperature, and electrical and/or electro-magnetic measurements captured while the plasma jet is incident on the interface at each of a set of points. The points may be distributed in any suitable pattern to provide coverage of the material. For example, for a 300 mm semiconductor wafer, the pattern may be a thirteen-point cross that spans the surface, with three points in each cardinal direction and one center point.

The characterization system 460 in one embodiment includes a data compressor 465, data scaling and transformation 470, and a trained machine learning model 480. In one embodiment, the data compressor 465 is local to the tester 450.

The data scaling and transformation 470 is used to scale the data. In one embodiment, the data ingestion module also is pre-processed to identify features. For example, in one embodiment, a feature extraction component analyzes optical emissions spectra to identify a set of peaks. Each peak may be represented by a peak intensity and a wavelength at which the peak intensity occurs. In some embodiments, values of a predetermined set of expected peaks (e.g., expected peaks for the optical emission spectrum of the gas used to the generate the plasma, such as Helium) may be removed or flagged. Alternatively, in some embodiments, no feature extraction is performed, and the full optical emissions spectra, electrical and/or electro-magnetic measurements, and/or temperature profile are used. The processed data is stored in one embodiment in data store 475. The raw sensor data 455 and/or processed data are used by the trained ML model 480.

The trained ML model characterizes one or more properties and/or performance of the material under test. The input to the ML model(s) 480 may be the raw optical emission spectra, surface temperature profiles, electrical data, electromagnetic data, and/or features extracted from raw data, or a combination of both. The ML model(s) 480 may provide characterization of a wide range of properties of the material. The electrical properties may include conductivity and resistivity. For example, the ML model(s) 480 may identify properties such as surface type, material composition, thickness, uniformity, presence of contaminants, etc. The ML model(s) 480 may also characterize physical characteristics such as crystal structures, grain boundaries, porosity, dislocation densities, etc. The ML model(s) 480 may further identify defects, such as pinholes, wrinkles, or contaminants. The ML model(s) 480 may also identify strain response metrics, which may include a piezoelectric coefficient. The ML model(s) 480 may also identify edges. The ML model(s) 480, in one embodiment, has multi-layer detection, the ability to get information about multiple material layers at the same time. The ML model(s) 480 may also identify wetting/adhesion properties. The ML model(s) 480 may also identify thermal properties such as diffusivity and conductivity of heat. In one embodiment, for some of the characterization, a mean and a variance provides confidence bounds of the characterization result.

In one embodiment, the trained ML model is an ensemble of decision trees learning model such as the random forest regression model, or another weighted neighborhoods scheme. In another embodiment, the trained ML model may include a plurality of different supervised and unsupervised learning models. In one embodiment, the supervised learning model uses non-linear regression and classification techniques. In one embodiment, the unsupervised learning model uses dimensionality reduction and clustering techniques to decipher latent information within the sensor data. In one embodiment, the unsupervised learning model may also be used for visualization (e.g., generating heatmaps in low-dimensional spaces). In one embodiment, supervised learning and unsupervised learning may be combined to perform regression and/or classification on the low-dimensional or latent spaces of the sensor data.

In one embodiment, the characterization system 460 may utilize different models for different characterizations.

Thus, the system uses an analysis of the synergistic interactions between the plasma and the material interface to measure and deduce surface and bulk physical and chemical properties of a material and use them to predict other qualities. In one embodiment, the system performs non-destructive measurements of chemical, thermal and electrical interactions of the plasma with incident materials in real time. It then passes this data to the trained machine learning system, which simultaneously predicts multiple critical material properties with (sub-) millimeter-scale spatial resolution in real-time.

For example, one type of sensor data that may be collected is Optical Emission Spectra (OES). OES comprises a rich source of information about dynamic changes in the chemistry of cold plasma interacting with a material.

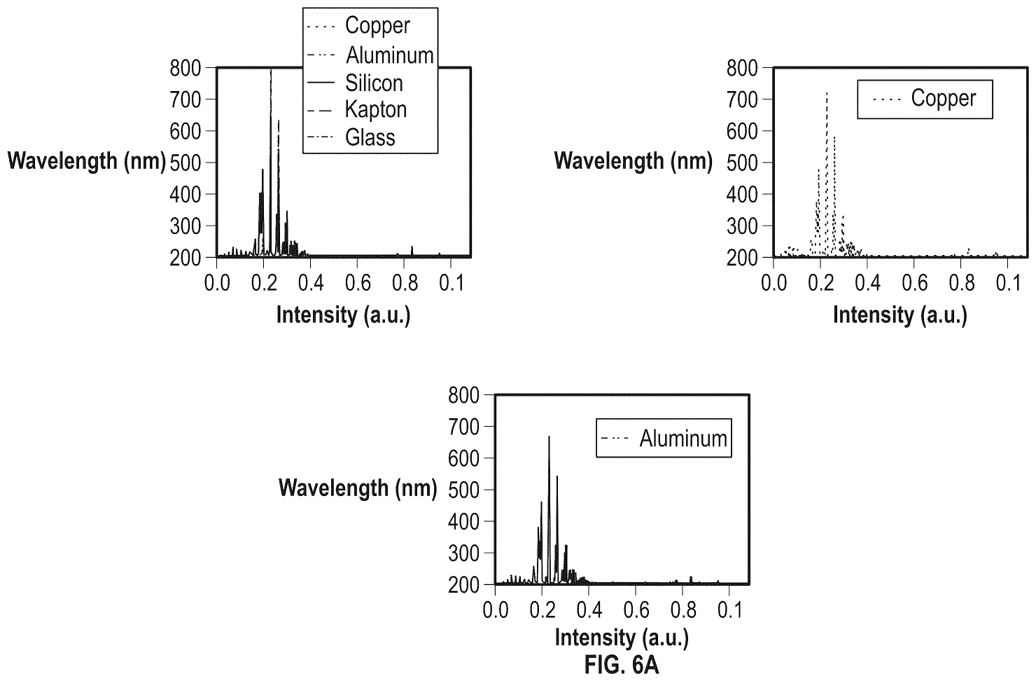

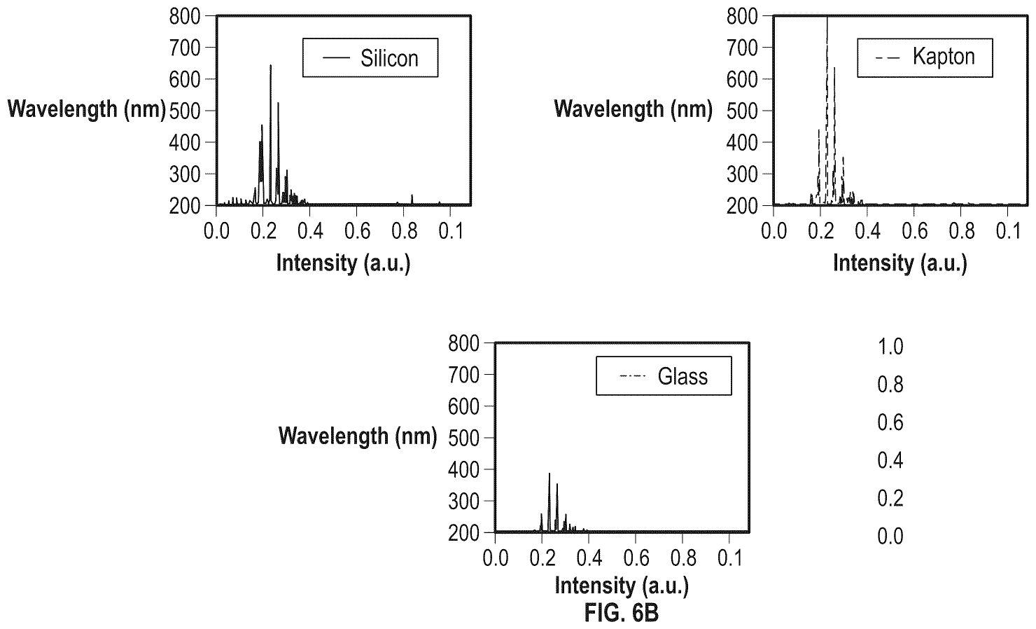

This information is captured by the presence, shape, and relative intensities of unique peaks within OES. Once the OES data is normalized, the intensity is, as intended, 1.0 at a characteristic emission wavelength in the collected spectra. This provides a basis for objective comparison among the materials since the key quantitative metrics within the OES (e.g., raw intensity values, peak ratios) are unique to each sample. Thus, the OES of the plasma-material interactions contain unique signatures about the chemical response of a material to cold plasma. For example, chemical species in the incident material can cause the appearance of unique peaks in the OES, the relative intensities of which correspond to these species' relative concentrations in the material. Thus, the OES of the plasma-material interactions contain unique signatures about the chemical response of a material to cold plasma. For example, chemical species in the incident material can cause the appearance of unique peaks in the OES, the relative intensities of which correspond to these species' relative concentrations in the material. FIGS. 6A-B illustrate optical emissions spectra from copper, aluminum, silicon, Kapton polyimide film, and glass samples. Each spectrum shown is an average of 60 OES measurements taken over 300 independent measurements of separate samples.

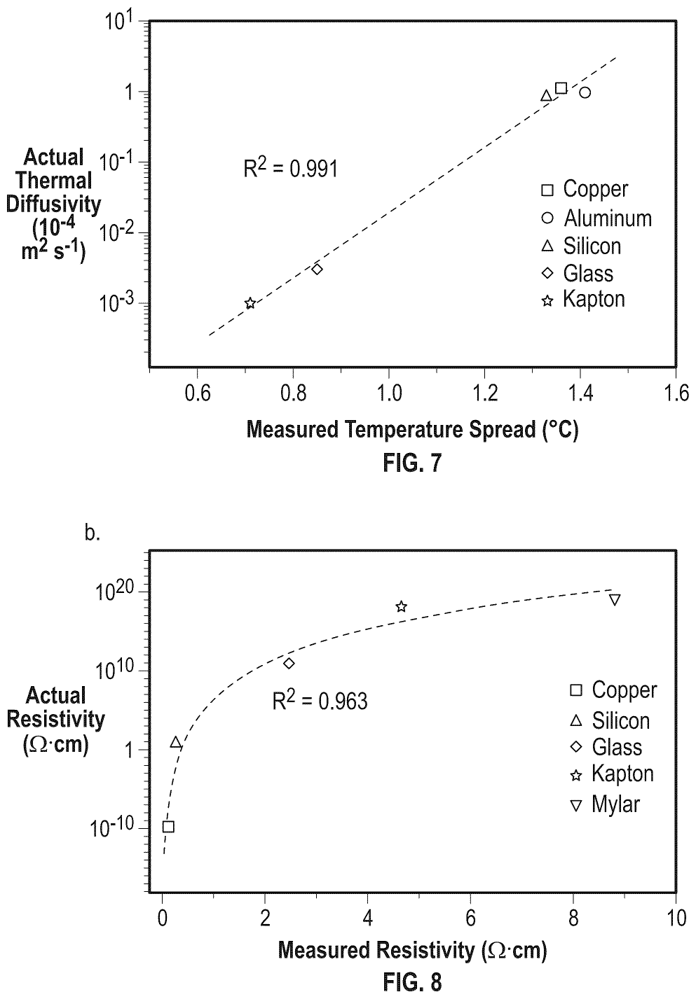

Additional raw data that may be obtained is thermal images of the materials. The thermal images correlate to the thermal diffusivity of each material. FIG. 7 illustrates the correlation between the distribution of surface temperature in response to the cold atmospheric plasma versus the known thermal diffusivity of each material, as reported in literature.

Additional raw data may include electrical or electromagnetic properties. For example, resistivity may be measured. FIG. 8 illustrates the correlation of the measured resistivity of various materials versus the known resistivity of each material, as reported in literature.

Additional sensors which may be used include various cameras, including hyperspectral camera, line-scan camera, Ultraviolet (UV) camera, visible range camera, near infrared camera, shortwave infrared camera, longwave infrared camera, or Raman spectroscopy camera.

Various use cases where different properties are characterized are described in greater detail below. In one embodiment, the characterization may include quantifications of traditional properties (e.g., physical, electrical, optical, mechanical, thermal, and chemical), application specific classifications (e.g., quality levels, pass/fail classifiers, defect percentage, binning categories), as well as predictions of functional properties (e.g., expected material performance, functional lifetime, wear characteristics, long-term stability). These characteristics in one embodiment can be used to determine how the tested material will be used.

The output of the ML model 480 is material characterization and evaluation, stored in material characterization datastore 485. The material characterization is associated with the particular tested material. This provides a useable characterized material 490, having a known set of characteristics.

### Example Method

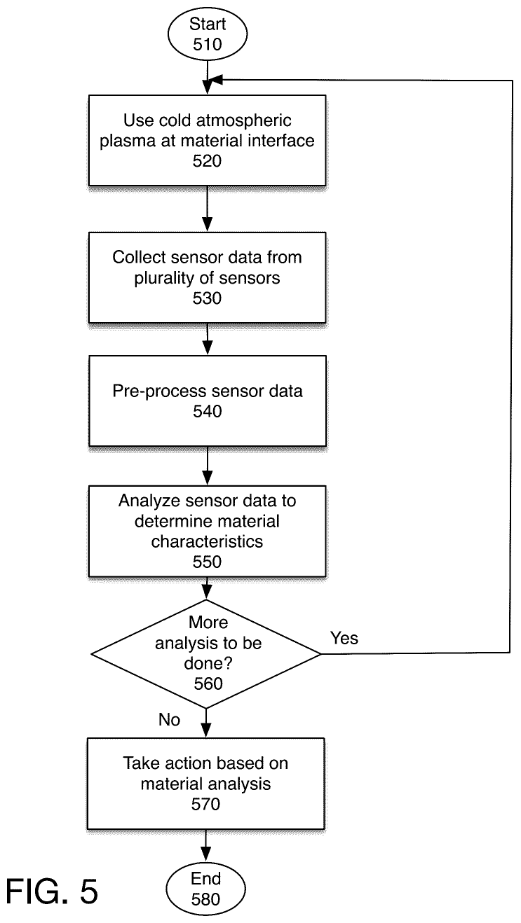

FIG. 5 is a flowchart of a method for characterizing one or more surface properties, according to one embodiment. The process starts at block 510. The process starts with

In the embodiment the cold atmospheric plasma is used at a material interface, at block 520. A plurality of sensors monitor this use. The sensor data is collected from the plurality of sensors at block 530. As described above, the plasma-surface interaction readings may include optical emissions spectra readings, surface temperature profiles captured for the surface with a plasma jet incident at a set of different points on the surface, and electrical and/or electromagnetic measurements of the plasma and surface. It should be appreciated that different or additional sensor readings of the interaction between the plasma jet and the surface may be used.

The sensor data is pre-processed in one embodiment, at block 540. In one embodiment, pre-processing may identify features in the sensor data. For example, the system may identify one or more peaks in an optical emissions spectrum. In other embodiments, the raw interactions readings are used without pre-processing.

At block 550, the sensor data is analyzed using one or more machine learning models. The machine learning models may use the extracted features and/or sensor data. The ML model(s) output characterizations of one or more characteristics of the material. The characteristics may include values for one or more of the surface type, material composition, thickness, uniformity, or presence of contaminants, etc. The generated classifications may be provided for display to a user. At block 560, the process determines whether there is more analysis to be done. If so, the process returns to block 520. In one embodiment, this analysis process may be real-time, and may take place multiple times for a single piece of material. The multiple instances may be at separate positions on the sample material, different offsets of the plasma, or other alterations of the setup to provide additional data. The data from multiple locations may be processed together or separately. There may be feedback between the separate readings, in one embodiment.

If there is not more analysis to be done, the process continues to block 570. At block 570, an action is taken based on the results of the material analysis. In one embodiment, the cold atmospheric testing process may be the last step during manufacturing, and the manufacturer may use the information derived from the testing to adjust manufacturing or usage of the tested materials. Because the testing is fast, non-destructive, and comprehensive, the adjustment may be to the use of the particular component, to the manufacturing process, etc.

For example, the system may identify a drift in values and uniformity of battery electrode thickness, mass loading, density, resistivity, chemical composition, and/or discover coating defects. Being aware of this may cause battery manufacturers to:
adjust coating gap, web tension, temperature, slurry flow rate during electrode coating,
adjust temperature or airflow (at multiple spatial locations),
adjust web speed during electrode drying, and/or adjust Calendering gap, Calendering force, temperature during Calendering,
discard the defective components; and/or. stop the line to correct for the cause of the drift.

For example, the system may identify a contaminate in the material. This can cause manufactures to:
Adjust slurry mixing to remove the contaminate;
Stop the line to correct for the cause of the contamination;
Investigate raw materials to identify the source of the contaminate;
discard the defective components; and/or
Measure environmental conditions to identify the source of the contamination.

For example, the system provides material property information, which can be used by manufactures to:
Identify “optimal” operating conditions for the material;
Identify “optimal” battery formulations;
Discover correlations between upstream sensor raw data and downstream product performance;
Identify drifts in machine performance;
Choose appropriate use for the classified components (e.g., using higher quality materials for uses which require higher consistency/quality);
Discard components which do not have necessary properties; and/or
Identify differences in battery performance among different line operators, which may lead to retraining or other changes in the process.

Other actions may be taken in response to the characterization. The process then ends at block 580.

### Example Use Cases

The following use cases provide examples of different surface categorizations that may be made using the approach described above. These examples are provided to demonstrate the versatility of the approach. It should be appreciated that these characterizations can be made substantially in real time and that multiple surface property characterizations can be determined at once.

Some of the use cases involve characterizing different types of materials or coatings. The measurements in the examples illustrated below were performed using a kHz-excited atmospheric pressure plasma jet using Helium. The tests were performed under similar operating parameters of the plasma jet. The ranges for the operating parameters of the plasma jet for these tests were: Helium flow rate: 1-5 slm, applied power 1.0 to 5.0 W, and sinusoidal voltage at 16 to 20 KHz frequency. These inputs yielded embedded voltage measurements from 1 to 2.5 kV, peak-to-peak applied voltage from 4 to 10 V, and embedded current measurements from 1.0 to 1.5 mA.

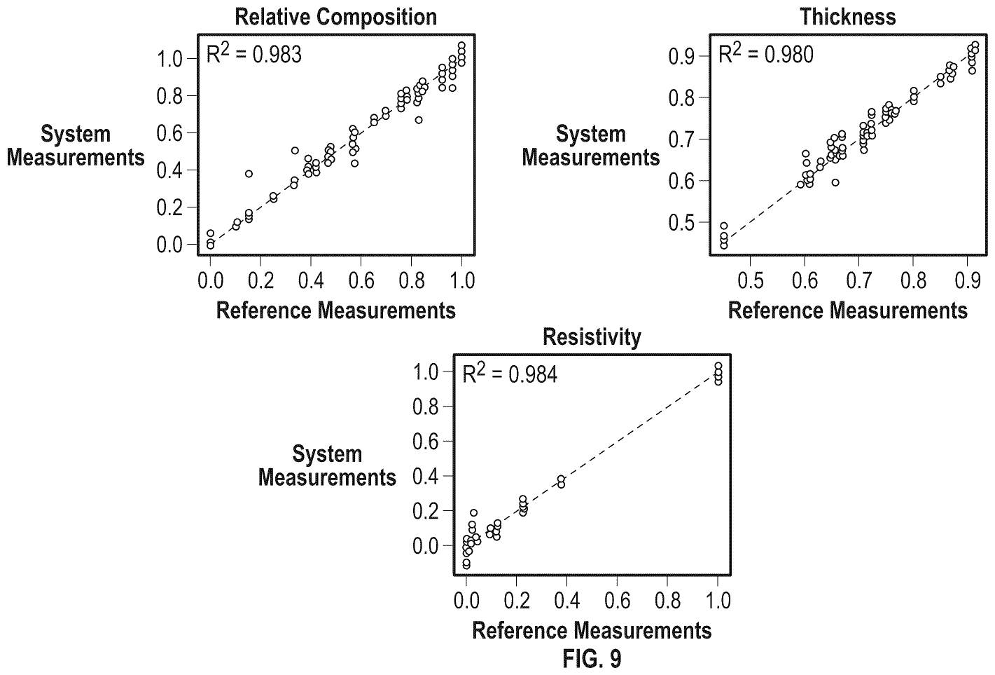

FIG. 9 illustrates the simultaneous measurement of relative composition, thickness, and resistivity of battery anode samples. The prior metrology solutions required separate sensors to measure each of these properties, while their relative composition measurements are destructive, and their resistivity measurements require undesirable surface contact. For this exemplary use case, the internal machine learning model was calibrated using 620 independent measurements across 30 anode coupons and tested using 180 independent measurements across 30 anode coupons as the holdout set (i.e., unseen to the calibrated model). FIG. 9 illustrates that the plasma-based measurement of the relative composition, thickness, and resistivity of the samples had high accuracy.

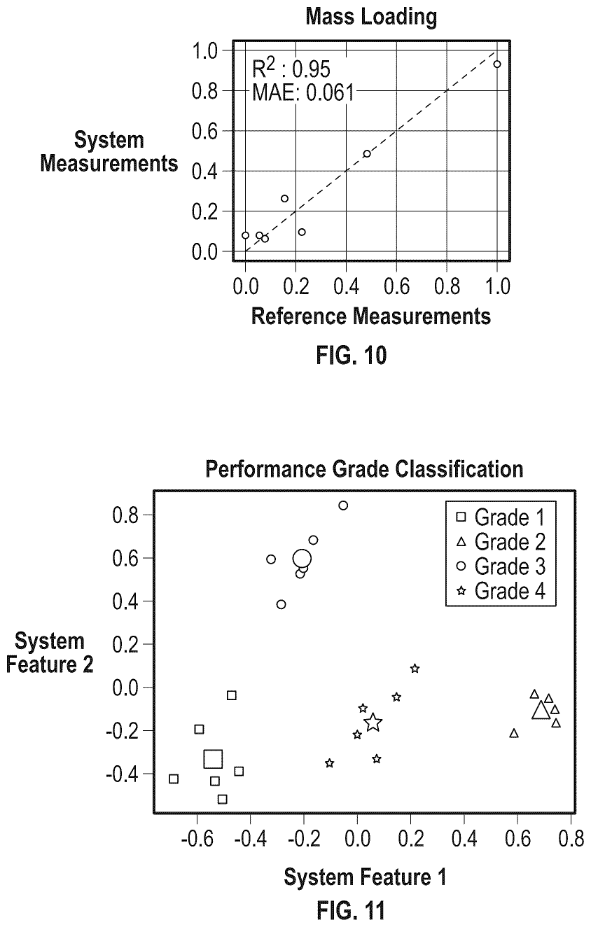

FIG. 10 illustrates an exemplary measurement of the mass loading of Lithium-ion battery anodes. With only 23 coupons of the anode sample (14 mm in diameter), the machine learning system was able to calibrate and test the sensor—16 coupons were used to calibrate the system and 7 coupons were used to test the calibration. FIG. 10 shows that the mass loading of the anode coupons was determined by the plasma characterization system with high accuracy. The prior method for measuring the mass loading of the anodes was to manually cut out coupons from larger sheets and then weigh these coupons on a scale. The present plasma characterization system allowed seamless and instant creation mass loading uniformity maps across anode rolls.

FIG. 11 illustrates an embodiment of performance grade classification of cathodes. This example was based on four classes of cathode samples, with different performance grades. Property information about the individual cathode samples was not revealed, and the machine learning model was trained using 96 reference measurements across the 4 classes of cathode samples. The machine learning system was able to detect the distinct performance grade of each cathode class for the provided 24 test measurements, as illustrated in FIG. 11.

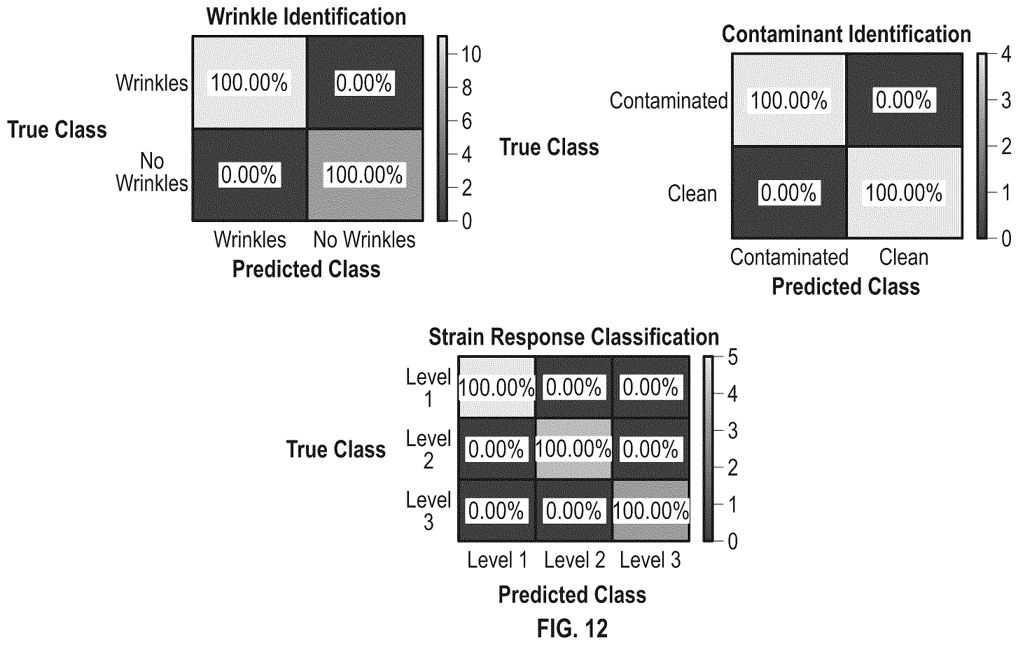

FIG. 12 illustrates an exemplary identification of contaminants and wrinkles and classification of the strain response of various polymer films used in electronics applications. The machine learning system was calibrated and tested are based on 210 independent measurements across 7 large reference samples with significant intra-sample variation. Approximately 170 measurements were used to train the model and ˜50 measurements were used to test the model as a hold out set. The machine learning system was able to correctly identify all contaminants and wrinkles in the holdout set, as shown in FIG. 12. The system also classified the relative strain response coefficient level with a classification accuracy of 100%.

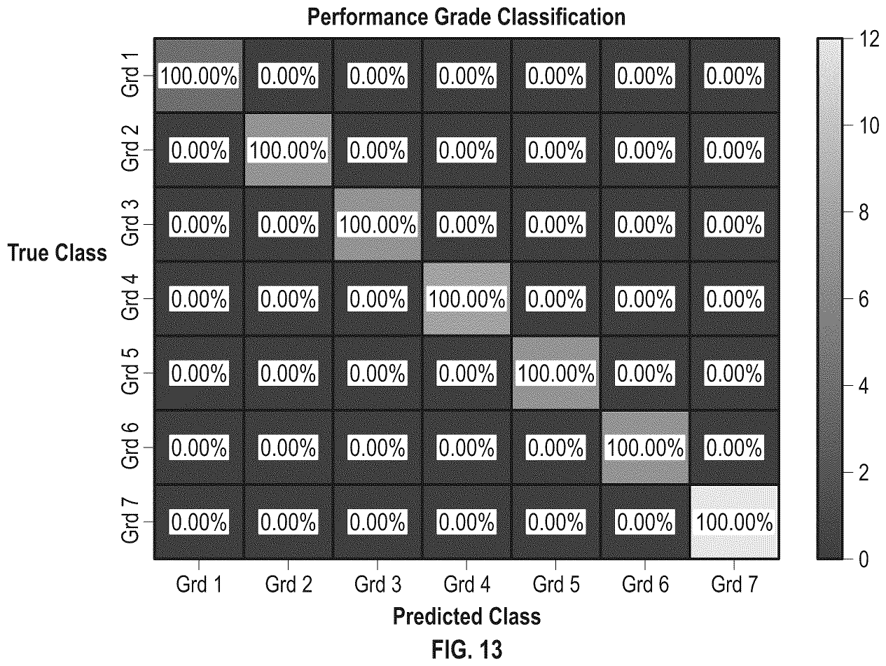

FIG. 13 illustrates an exemplary performance grade classification for seven classes of membranes. The system was trained with seven classes of membrane samples with different performance grades. In this example, 256 independent measurements across 16 membrane coupons were used for calibration of the internal model to classify the performance grade of the samples. As shown in FIG. 13, the machine learning system successfully classified the membrane performance grades with 100% accuracy for the provided test measurements.

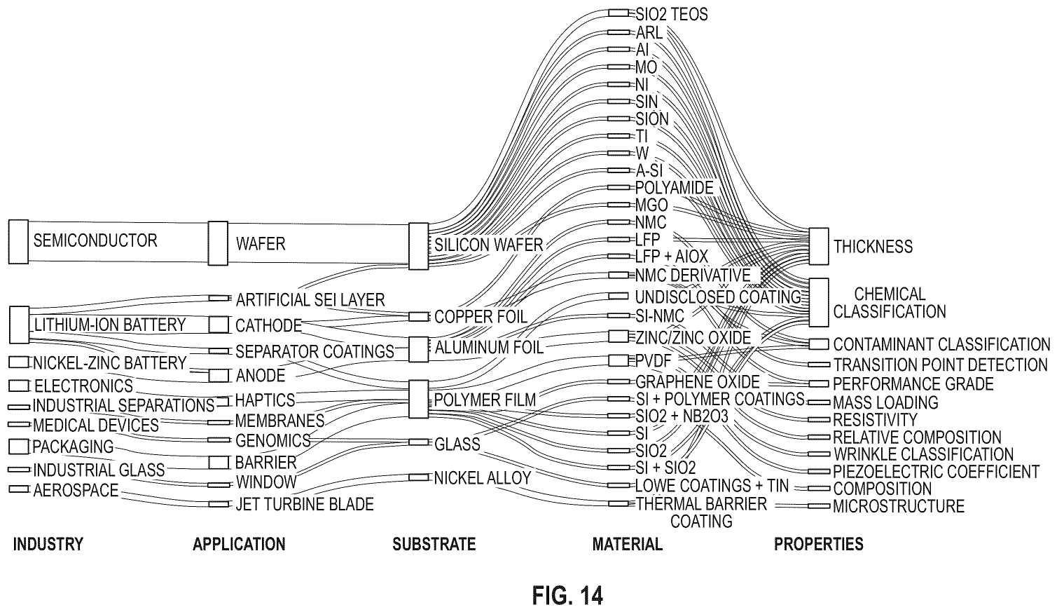

FIG. 14 is Sankey Chart showing one embodiment of exemplary types of materials analyzed and characteristics identified. The diagram illustrates for example various industries in which the material characterization may be used, and the component application, and associated substrate(s). The materials that are part of the application are also listed, and the various properties that the machine learning system can identify are listed as well. The graphic shows for example that for the semiconductor industry, the system may be used to analyze a wafer, with a silicon wafer substrate. The elements in the wafer are listed. For the wafer, as well as the various components, the system can determine thickness, chemical classification, contaminant classification, for example. This is merely an exemplary set of uses for the machine learning system described.

### Computing System Architecture

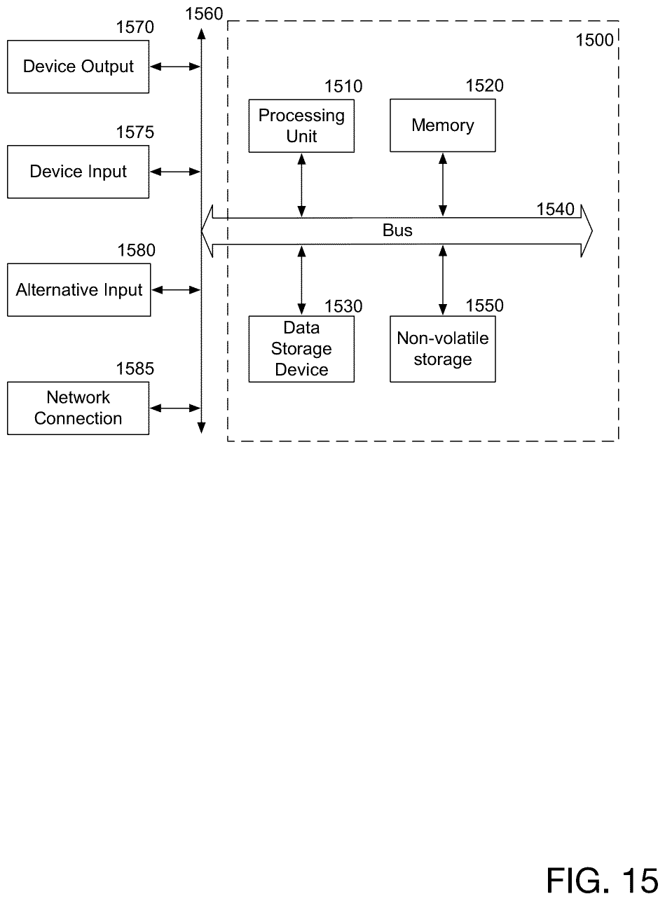

FIG. 15 is a block diagram of a particular machine that may be used with the present invention. It will be apparent to those of ordinary skill in the art, however that other alternative systems of various system architectures may also be used.

The data processing system illustrated in FIG. 15 includes a bus or other internal communication means 1540 for communicating information, and a processing unit 1510 coupled to the bus 1540 for processing information. The processing unit 1510 may be a central processing unit (CPU), a digital signal processor (DSP), or another type of processing unit 1510.

The system further includes, in one embodiment, a random access memory (RAM) or other volatile storage device 1520 (referred to as memory), coupled to bus 1540 for storing information and instructions to be executed by processor 1510. Main memory 1520 may also be used for storing temporary variables or other intermediate information during execution of instructions by processing unit 1510.

The system also comprises in one embodiment a read only memory (ROM) 1550 and/or static storage device 1550 coupled to bus 1540 for storing static information and instructions for processor 1510. In one embodiment the system also includes a data storage device 1530 such as a magnetic disk or optical disk and its corresponding disk drive, or Flash memory or other storage, which is capable of storing data when no power is supplied to the system. Data storage device 1530 in one embodiment is coupled to bus 1540 for storing information and instructions.

The system may further be coupled to an output device 1570, such as a cathode ray tube (CRT) or a liquid crystal display (LCD) coupled to bus 1540 through bus 1560 for outputting information. The output device 1570 may be a visual output device, an audio output device, and/or tactile output device (e.g. vibrations, etc.)

An input device 1575 may be coupled to the bus 1560. The input device 1575 may be an alphanumeric input device, such as a keyboard including alphanumeric and other keys, for enabling a user to communicate information and command selections to processing unit 1510. An additional user input device 1580 may further be included. One such user input device 1580 is cursor control device 1580, such as a mouse, a trackball, stylus, cursor direction keys, or touch screen, may be coupled to bus 1540 through bus 1560 for communicating direction information and command selections to processing unit 1510, and for controlling movement on display device 1570.

Another device, which may optionally be coupled to computer system 1500, is a network device 1585 for accessing other nodes of a distributed system via a network. The communication device 1585 may include any number of commercially available networking peripheral devices such as those used for coupling to an Ethernet, token ring, Internet, or wide area network, personal area network, wireless network, or other method of accessing other devices. The communication device 1585 may further be a null-modem connection, or any other mechanism that provides connectivity between the computer system 1500 and the outside world.

Note that any or all of the components of this system illustrated in FIG. 15 and associated hardware may be used in various embodiments of the present invention.

It will be appreciated by those of ordinary skill in the art that the particular machine that embodies the present invention may be configured in various ways according to the particular implementation. The control logic or software implementing the present invention can be stored in main memory 1520, mass storage device 1530, or other storage medium locally or remotely accessible to processor 1510.

It will be apparent to those of ordinary skill in the art that the system, method, and process described herein can be implemented as software stored in main memory 1520 or read only memory 1550 and executed by processor 1510. This control logic or software may also be resident on an article of manufacture comprising a computer readable medium having computer readable program code embodied therein and being readable by the mass storage device 1530 and for causing the processor 1510 to operate in accordance with the methods and teachings herein.

The present invention may also be embodied in a handheld or portable device containing a subset of the computer hardware components described above. For example, the handheld device may be configured to contain only the bus 1540, the processor 1510, and memory 1550 and/or 1520.

The handheld device may be configured to include a set of buttons or input signaling components with which a user may select from a set of available options. These could be considered input device #1 1575 or input device #2 1580. The handheld device may also be configured to include an output device 1570 such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above, such as a kiosk or a vehicle. For example, the appliance may include a processing unit 1510, a data storage device 1530, a bus 1540, and memory 1520, and no input/output mechanisms, or only rudimentary communications mechanisms, such as a small touchscreen that permits the user to communicate in a basic manner with the device. In general, the more special purpose the device is, the fewer of the elements need be present for the device to function. In some devices, communications with the user may be through a touch-based screen, or similar mechanism. In one embodiment, the device may not provide any direct input/output signals but may be configured and accessed through a website or other network-based connection through network device 1585.

It will be appreciated by those of ordinary skill in the art that any configuration of the particular machine implemented as the computer system may be used according to the particular implementation. The control logic or software implementing the present invention can be stored on any machine-readable medium locally or remotely accessible to processor 1510. A machine-readable medium includes any mechanism for storing information in a form readable by a machine (e.g. a computer). For example, a machine readable medium includes read-only memory (ROM), random access memory (RAM), magnetic disk storage media, optical storage media, flash memory devices, or other storage media which may be used for temporary or permanent data storage. In one embodiment, the control logic may be implemented as transmittable data, such as electrical, optical, acoustical, or other forms of propagated signals (e.g. carrier waves, infrared signals, digital signals, etc.).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient, at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B are true (or present).

Upon reading this disclosure, those of skill in the art will appreciate still additional alternative structural and functional designs for a system and a process for characterizing surfaces with a ML model using data describing the interactions between the surfaces and cold atmospheric plasmas. Thus, while particular embodiments and applications have been illustrated and described, it is to be understood that the described subject matter is not limited to the precise construction and components disclosed. The scope of protection should be limited only by the following claims.

We claim:

1. A method of characterizing and evaluating a material comprising:
applying a cold atmospheric plasma to an interface with the material;
measuring a plurality of interactions between the plasma and the interface using a plurality of sensors to generate sensor data;
utilizing a trained machine learning model to analyze the sensor data to generate characterization of the material based on the interactions, the characterization comprising one or more of bulk properties and surface properties of the material.

2. The method of claim 1, wherein the sensor data comprises one or more of:
physical properties, electrical properties, electro-magnetic properties, chemical properties, and thermal properties.

3. The method of claim 2, wherein the plurality of sensors comprise one or more of: an optical emission spectrometer (OES), a thermal imaging sensor, an electrical detector, an UV-Vis spectrometer, a camera, a hyperspectral camera, a line-scan camera, an Ultraviolet (UV) camera, a visible range camera, a near infrared camera, a shortwave infrared camera, a longwave infrared camera, or a Raman spectroscopy camera.

4. The method of claim 1, further comprising:
applying a bias to one of: the material and a base that the material is on, during the measuring.

5. The method of claim 1, wherein the characterization is generated in real time.

6. The method of claim 4, wherein the trained machine learning model characterizes multiple properties in parallel.

7. The method of claim 1, wherein the machine learning model comprises a physics-informed model calibrated for material properties and evaluation.

8. The method of claim 1, further comprising:
scaling and transforming the sensor data.

9. The method of claim 1, further comprising:
one of the characterizations including a mean and a variance providing confidence bounds.

10. The method of claim 1, wherein the machine learning model comprises a combination of supervised learning using non-linear regression and classification techniques and unsupervised learning using dimensionality reduction and clustering techniques to decipher latent information within the sensor data.

11. The method of claim 1, wherein the machine learning model is calibrated using a probabilistic model.

12. The method of claim 11, wherein the probabilistic model is one of: a Gaussian process regression model and Bayesian neural network.

13. The method of claim 1, wherein the characterization includes one or more of: a surface type, thickness and uniformity, density, resistivity, chemical composition, contaminate, mass loading, and defect identification for thin-films and other coatings, strain response metrics, edge detection, multi-layer detection, as well as broader classifications related to material performance.

14. The method of claim 1, comprising:
compressing the sensor data;
analyzing the sensor data to identify features in the data, the features including peaks in spectroscopy data.

15. A characterization system to characterize a material comprising:
a plurality of sensors to measure interactions between a cold atmospheric plasma and an interface of the material, the plurality of sensors generating sensor data;
a trained machine learning model to analyze the sensor data to generate characterization of bulk properties of the material based on the interactions.

16. The system of claim 15, wherein the sensor data comprises one or more of: physical properties, electrical properties, electro-magnetic properties, chemical properties, and thermal properties.

17. The system of claim 16, wherein the plurality of sensors comprise one or more of: an optical emission spectrometer (OES), a thermal imaging sensor, an electrical detector, a UV-Vis spectrometer, and an infrared camera.

18. The system of claim 16, wherein the machine learning model comprises a physics-informed model calibrated for material properties.

19. The system of claim 15, wherein the machine learning system is further to provide a mean and a variance providing confidence bounds for one of the characterizations.

20. The system of claim 15, wherein the machine learning model comprises of a combination of supervised and unsupervised learning methods.

21. The system of claim 15, wherein the machine learning model is calibrated using a probabilistic model.

22. The system of claim 21, wherein the probabilistic model is one of: a Gaussian process regression model and a Bayesian neural network.

23. The system of claim 15, wherein the characterization includes one or more of a surface type, thickness and uniformity, density, resistivity, chemical composition, contaminate, mass loading, and defect identification for thin-films and other coatings, as well as broader classifications related to material performance.

24. The system of claim 15, comprising:
a data ingestion module to compress the sensor data and apply data scaling and transformation to the sensor data.

25. A method of characterizing and evaluating a material comprising:
applying a cold atmospheric plasma to an interface with the material;
measuring a plurality of interactions between the plasma and the interface using a plurality of sensors to generate sensor data;
analyzing the sensor data to generate characterization of the material based on the interactions, the characterization comprising one or more of bulk properties and surface properties of the material.
